(19) United States
(12) Patent Application Publication
(10) Pub. No.: US 2010/0086821 A1
(43) Pub. Date: Apr. 8, 2010

(54) ELECTRODE FOR POLYMER ELECTROLYTE MEMBRANE FUEL CELL, MEMBRANE-ELECTRODE ASSEMBLY, AND METHODS FOR MANUFACTURING THE SAME

(75) Inventors: Nak Hyun Kwon, Seoul (KR); Tae Won Lim, Seoul (KR); In Chul Hwang, Gyeonggi-do (KR); Byung Ki Ahn, Gyeonggi-do (KR); Jae Seung Lee, Seoul (KR); Ki Sub Lee, Seoul (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 12/361,076

(22) Filed: Jan. 28, 2009

(30) Foreign Application Priority Data
Oct. 6, 2008 (KR) 10-2008-0097559

(51) Int. Cl. H01M 8/10; H01M 4/00; B05D 3/00

(52) U.S. Cl. 429/30; 429/40; 427/565

(57) ABSTRACT

The present invention provides a method for manufacturing a membrane-electrode assembly (MEA) which is a core element of a polymer electrolyte membrane fuel cell for a vehicle and an electrode therefor. The method for manufacturing an MEA of the present invention is implemented to provide a highly-concentrated catalyst slurry which is uniformly dispersed, compared to conventional catalyst slurries, by a catalyst slurry manufacturing process including a vacuum defoaming process.

### CROSS-REFERENCE TO RELATED APPLICATION

This application claims under 35 U.S.C. §119(a) the benefit of Korean Patent Application No. 10-2008-0097559 filed Oct. 6, 2008, the entire contents of which are incorporated herein by reference.

### BACKGROUND

(a) Technical Field

The present disclosure relates to an electrode for a polymer electrolyte membrane fuel cell, a membrane-electrode assembly (MEA) including the same, and methods for manufacturing the same. The invention also relates to an electrode used in a polymer electrolyte membrane fuel cell (PEMFC) for a vehicle, a membrane-electrode assembly including the same, and methods for manufacturing an electrode for a polymer electrolyte membrane fuel cell and a membrane-electrode assembly having high performance and optimally designed using a catalyst slurry prepared by a highly-concentrated catalyst dispersion method.

(b) Background Art

The present invention relates to a method for manufacturing a membrane-electrode assembly (MEA) which is a core element of a polymer electrolyte membrane fuel cell for a vehicle. In order to manufacture an MEA catalyst electrode of the polymer electrolyte membrane fuel cell, it is first necessary to develop a highly-dispersed catalyst slurry having high fluidity. However, a technical method for uniformly dispersing nano-sized catalyst particles in high concentration is not known. Techniques for dispersing catalyst particles in low concentration have been reported.

According to a generally applicable method for manufacturing an electrode, a catalyst slurry of low concentration is suitably prepared and used to manufacture an electrode by spray coating since it is difficult to disperse catalyst particles in high concentration. However, when using such a method, the rate of catalyst loss is increased, and so the catalyst should be coated several times, which then results in an increase in the processing time, thus increasing the manufacturing cost.

According to a catalyst slurry dispersion technique, it is possible that ionomers in catalyst particles can be filled into primary pores by applying high pressure; however, in using this technique, it can be difficult to perform the manufacturing process, and there may be limitations associated with the ionomer filling since an air layer in the primary pores is not completely removed.

Conventional methods for suitably manufacturing the MEA include a catalyst-coated membrane (CCM) method in which an electrode layer is formed on a polymer electrolyte membrane, a catalyst-coated GDL (CCG) method in which a catalyst layer is formed on gas diffusion layers (GDLs), etc. A decal method, which is an indirect decal process used in the CCM method, has also been described; however, none of the above-mentioned methods are highly applicable for suitably manufacturing the MEA.

Using the decal method, which corresponds to the CCM method, it is easy to control the thickness and area of the catalyst layer, which ensures high mass productivity. Thus, using the decal method, it is possible to reduce contact resistance between the polymer electrolyte membrane and the catalyst layer, as compared to the CCG method, and it is possible to form a dense catalyst layer by thermocompression during decaling, thus improving the durability. However, a catalyst layer formed by the decal method may have a reducedporosity, and thus the initial cell performance may be deteriorated, as compared to the CCG method.

Accordingly, it is necessary to provide a method for manufacturing a membrane-electrode assembly, which is optimally designed using a catalyst slurry of high efficiency prepared by a highly-concentrated catalyst dispersion method that reduces catalyst loss and improves catalyst utilization.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

In one aspect, the present invention provides an electrode for a polymer electrolyte membrane fuel cell, a membrane-electrode assembly including the same, and methods for manufacturing the same. According to preferred embodiments of the present invention, a highly-concentrated catalyst slurry which is uniformly dispersed, compared to conventional catalyst slurries, is suitably provided to improve catalyst utilization, and the ratio of solvents used in catalyst slurry dispersion is preferably controlled to improve electrode performance, thus manufacturing an optimally designed membrane-electrode assembly. According to other preferred embodiments of the invention, the present invention provides methods for manufacturing an electrode for a polymer electrolyte membrane fuel cell and a membrane-electrode assembly including the same by a decal method, which can suitably prevent performance deterioration of the fuel cell, which is caused when manufacturing the membrane-electrode assembly by a conventional decal method, to ensure high mass productivity, reduce contact resistance between catalyst layers, and improve the durability of the membrane-electrode assembly.

In one preferred aspect, the present invention provides a method for suitably manufacturing an electrode for a polymer electrolyte membrane fuel cell, the method preferably including: dispersing initial catalyst particles by ultrasonic waves and high-speed stirring; allowing ionomers to be filled and adsorbed into primary pores of the catalyst particles by vacuum defoaming; dispersing a small amount of residual large catalyst particles by bead milling; removing microbubbles generated during manufacturing process; forming a catalyst slurry from which large catalyst particles are removed by final filtering; and coating the catalyst slurry on a surface of a release film and drying the coated catalyst slurry.

In a particular preferred embodiment, a mixed solvent of isopropyl alcohol and water is preferably used when dispersing the catalyst particles, and the mixed solvent further includes at least one selected from, but not limited to, the group consisting of ethoxyethanol, butoxyethanol, and N-methylpyrrolidone (NMP) in an amount of 0.1 to 50%.

In still another preferred embodiment, in the step of drying the coated catalyst slurry, the drying process preferably includes a first heat treatment process suitably performed at 70 to 90° C. for more than 10 hours and a second heat treatment suitably performed at 100 to 120° C. for more than 30 minutes.

In another embodiment, the present invention provides an electrode for a polymer electrolyte membrane fuel cell manufactured by one of the above-described methods.

In still another preferred aspect, the present invention provides a method for suitably manufacturing a membrane-electrode assembly for a polymer electrolyte membrane fuel cell, the method preferably including: dispersing initial catalyst particles by ultrasonic waves and high-speed stirring; allowing ionomers to be filled and adsorbed into primary pores of the catalyst particles by vacuum defoaming; dispersing a small amount of residual large catalyst particles by bead milling; removing microbubbles generated during manufacturing process; forming a catalyst slurry from which large catalyst particles are removed by final filtering; forming a catalyst layer by coating the catalyst slurry on a surface of a release film and drying the coated catalyst slurry; and forming a 3-layer membrane-electrode assembly by decaling the formed catalyst layer on both sides of a polymer electrolyte membrane using a hot press.

In a preferred embodiment, the method further includes forming a 5-layer membrane-electrode assembly by suitably bonding a gas diffusion layer (GDL) on both sides of a 3-layer membrane-electrode assembly.

In another preferred embodiment, a mixed solvent of water and isopropyl alcohol or ethanol is used when dispersing the catalyst particles, and the mixed solvent further includes at least one selected from the group consisting of, but not limited to, ethoxyethanol, butoxyethanol, and N-methylpyrrolidone (NMP) in an amount of 0.1 to 50%.

In still another preferred embodiment, in the step of drying the coated catalyst slurry, the drying process preferably includes a first heat treatment process suitably performed at 70 to 90° C. for more than 10 hours and a second heat treatment suitably performed at 100 to 120° C. for more than 30 minutes.

In yet another aspect, the present invention provides a membrane-electrode assembly for a polymer electrolyte membrane fuel cell manufactured by the above-described method.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a flowchart illustrating a method for manufacturing a membrane-electrode assembly (MEA) using a highly-concentrated and dispersed catalyst slurry in accordance with the present invention, in which (a) shows a catalyst dispersion process including a catalyst dispersion model for improving catalyst utilization, and (b) shows an MEA manufacturing process including electrode coating and decal processes;

FIG. 2 is a flowchart illustrating a process of manufacturing a highly-concentrated and dispersed catalyst slurry;

FIGS. 3A and 3B are scanning electron microscope (SEM) images for comparing the surfaces of catalyst layers according to catalyst slurry manufacturing conditions; and

FIGS. 4A and 4B are field emission scanning electron microscope (FE-SEM) images of an MEA manufactured by the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

As described herein, the present invention includes a method for manufacturing an electrode for a polymer electrolyte membrane fuel cell, the method comprising dispersing initial catalyst particles, allowing ionomers to be filled and adsorbed into primary pores of the catalyst particles, dispersing a small amount of residual large catalyst particles, removing microbubbles generated during manufacturing process, forming a catalyst slurry; and coating the catalyst slurry on a surface of a release film.

In one embodiment, the initial catalyst particles are dispersed by by ultrasonic waves and high-speed stirring.

In another embodiment, the ionomers are filled and adsorbed into primary pores of the catalyst particles by vacuum defoaming.

In another embodiment, the small amount of residual large catalyst particles are dispersed by bead milling.

In a related embodiment, large catalyst particles are removed from the catalyst slurry by final filtering.

In still another related embodiment, the method further comprises the step of drying the coated catalyst slurry.

In another further embodiment, the method comprises a step of forming a 3-layer membrane-electrode assembly.

In a related embodiment, the step of forming a 3-layer membrane-electrode assembly is carried out by decaling the formed catalyst layer on both sides of a polymer electrolyte membrane using a hot press.

In another aspect, the invention also features a motor vehicle comprising an electrode for a polymer electrolyte membrane fuel cell of manufactured by any one of the methods described in the aspects and embodiments herein.

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

In preferred aspect, the present invention provides a method for manufacturing an electrode having high performance using a highly-concentrated and dispersed catalyst slurry suitably prepared to improve catalyst utilization and a method for manufacturing a membrane-electrode assembly (MEA) having suitably high performance under optimally designed bonding conditions.

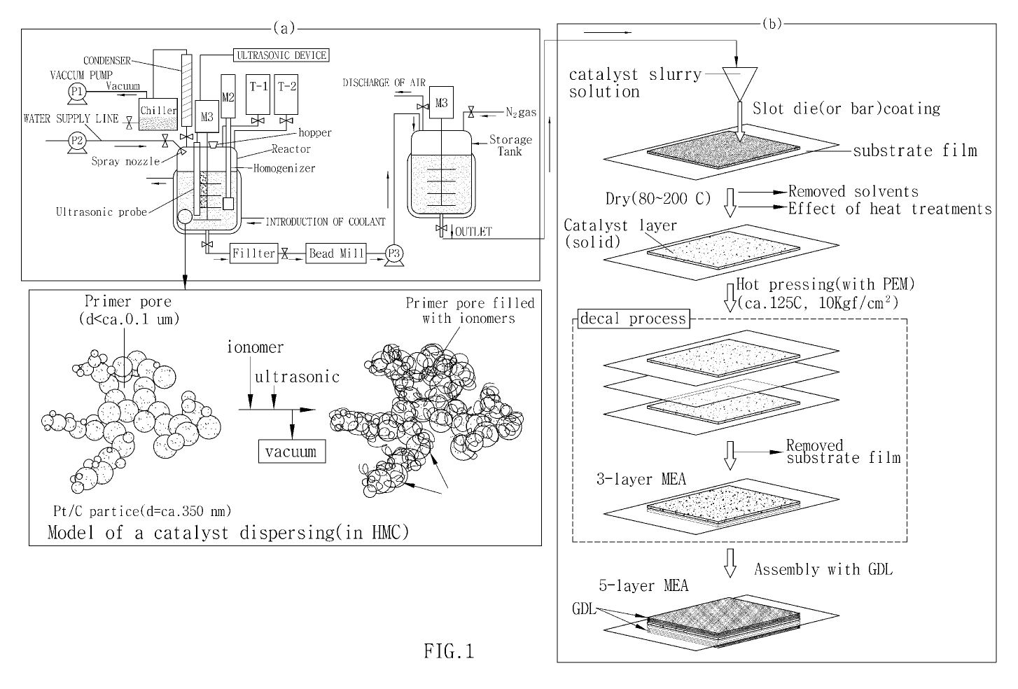

FIG. 1 is a flowchart illustrating a method for manufacturing a membrane-electrode assembly (MEA) including a catalyst dispersion process and a preferred MEA manufacturing process according to preferred embodiments of the present invention. In order to implement the method for manufacturing an MEA having high performance in accordance with certain preferred embodiments of the present invention, a method for manufacturing a highly-concentrated and dispersed catalyst slurry (CS) for optimizing a catalyst layer (CL) of an electrode used in the MEA has been suitably developed.

Generally, in order to design the catalyst layer, it is first necessary to develop a highly-dispersed catalyst slurry having suitable high fluidity. In certain preferred embodiments, in order to suitably reduce the manufacturing cost in consideration of a mass production, it is preferably necessary to form the catalyst layer by coating the catalyst slurry once. Accordingly, in certain embodiments, the catalyst slurry should have a viscosity of 100 to 10,000 cps, and a concentration of more than 10% to suitably ensure the workability. Preferably, in order to uniformly disperse nano-sized catalyst particles in high concentration, it is necessary to adopt a preferred method. Certain reasons for this are as described herein. The catalyst particles are conglomerated by electrostatic forces in the air and present in a particle size of several to several tens of micrometers. When a solvent and an ionomer are added to the catalyst particles and then dispersed by ultrasonic waves and high-speed stirring, most of the catalyst particles are uniformly dispersed in a particle size of 0.4 to 2.0 μm. However, a portion of them are not dispersed but are present as large particles having a larger particle size, for example a particle size of more than 10 μm, which becomes more serious when they are present at a high concentration of more than 10 wt %. In certain preferred embodiments, for example in the case where the catalyst slurry containing the large particles is coated on a support (e.g., release film, MEM, or GDL), the large particles may generate scratches and cause a coating defect, thus deteriorating the coating quality. In further embodiments, the catalyst layer containing conglomerated catalyst particles suitably decreases the catalyst utilization, which causes performance deterioration of the MEA.

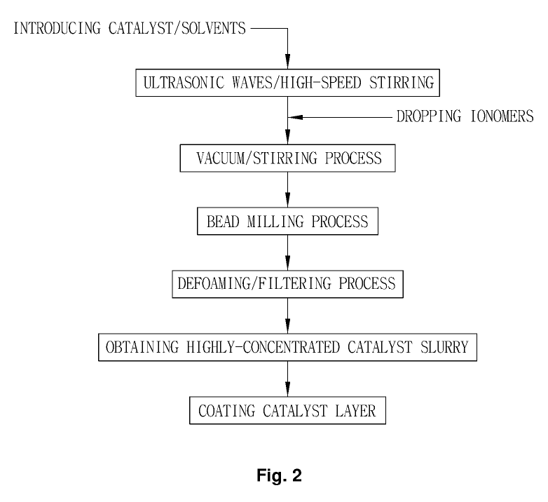

In preferred aspects of the present invention, a vacuum process is suitably introduced during manufacturing the catalyst slurry in order to overcome the above-described problems and improve catalyst dispersion and catalyst utilization (see (a) of FIG. 1 and FIG. 2). That is, as shown in (a) of FIG. 1 and FIG. 2, in certain preferred embodiments, the present invention introduces a vacuum defoaming process to create a vacuum state during dispersion process so that oxygen bubbles having a small diameter and adsorbed on the catalyst surface are suitably removed. As a result, according to further preferred embodiments, surface wetting by solvents is suitably improved, and thus the contact area exposed to the solvents is suitably increased, which results in an improvement in the dispersion of catalyst particles into the solvents and an improvement in the fluidity of catalyst slurry. According to further embodiments, ionomers can be readily filled into primary pores preferably having a diameter of less than 100 nm which are developed in a carbon support of Pt-M/C catalyst preferably having a diameter of several tens of nanometers, and thus the adsorption rate is suitably increased, which results in an increase in platinum catalyst utilization.

According to further preferred embodiments of the present invention, a catalyst slurry capable of being highly-dispersed in high concentration is suitably prepared by the above-described methods, and a membrane-electrode assembly having high performance is suitably manufactured using the same. Especially, in an apparatus for manufacturing a highly-concentrated and dispersed catalyst slurry, a spray device that delays catalyst activation by uniformly wet the catalyst powder with water is preferably provided to prevent solvents, for example, but not limited to isopropyl alcohol (IPA), from being directly in contact with platinum catalyst and causing a fire. In further preferred embodiments, an ultrasonic device, a high-speed stirrer, and a homogenizer are preferably provided in the apparatus so as to be simultaneously used to enable highly-concentrated catalyst dispersion. According to further preferred embodiments, the apparatus is suitably designed to maintain a vacuum state during dispersion in order to achieve high catalyst dispersion and catalyst utilization. In still other preferred embodiments, a bead milling process capable of dispersing large undispersed catalyst particles is preferably introduced to optimize the dispersion.

In the present invention, in addition to the catalyst dispersion technique during manufacturing the electrode in the above-described apparatus, the preferred ratio of solvents used in the catalyst slurry dispersion is suitably controlled to ensure uniform coating and prevent the occurrence of cracks, thus suitably improving the electrode performance.

In general, the solvents used by a variety of researchers in the process of manufacturing the catalyst slurry include, but are not limited to, isopropyl alcohol (or ethanol) and water, in which the mixing ratio is 40 to 80% of isopropyl alcohol (IPA) and 20 to 60% of water (H₂O).

In certain exemplary embodiments, the mixed solvent of IPA and H₂O has a considerable influence on the manufacturing process and properties of the catalyst layer, which will be described below. Since isopropyl alcohol (b.p. 82° C., d. 0.782) has a boiling point lower than that of water and its drying ratio is considerably fast, a solvent gradient is instantaneously generated in the catalyst slurry which is still in a liquid phase during the drying process. As a result, in certain exemplary embodiments, a portion where the concentration of isopropyl alcohol is locally high is completely dried, and the other portion where the concentration of water is high is not dried. In this state, condensation occurs from the dried portion to cause cracks on the catalyst layer after being completely dried. According to further embodiments, due to rapid volatilization of isopropyl alcohol, ionomers uniformly distributed in a catalyst slurry solution preferably migrate to the surface of the catalyst layer at the same time. As a result, the concentration distribution of ionomers in the catalyst layer becomes suitably ununiform after being completely dried, which results in suitable deterioration of MEA performance.

To address the above-described problems, the present invention has examined other solvents than isopropyl alcohol (IPA) and water (H₂O), such as, but not limited to, glycerols and cellusolves having good miscibility with catalyst and ionomer. As a result of examining the solvents as described herein, 2-ethoxyethanol (EE; b.p. 134° C., d. 0.931) has appropriate specific gravity and boiling point as well as good miscibility with isopropyl alcohol and water. In order to use 2-ethoxyethanol in the manufacturing process of the catalyst slurry, an appropriate amount of 2-ethoxyethanol has been suitably examined. Accordingly, it was seen that the appropriate amount of 2-ethoxyethanol is about 5%, 10%, 15%, 20%, 25%, 30%, 35%, 40%, 45%, 50%, preferably 10 to 30% within the range of 0.1 to 50% with respect to the total ratio of solvents used in the catalyst slurry mixing.

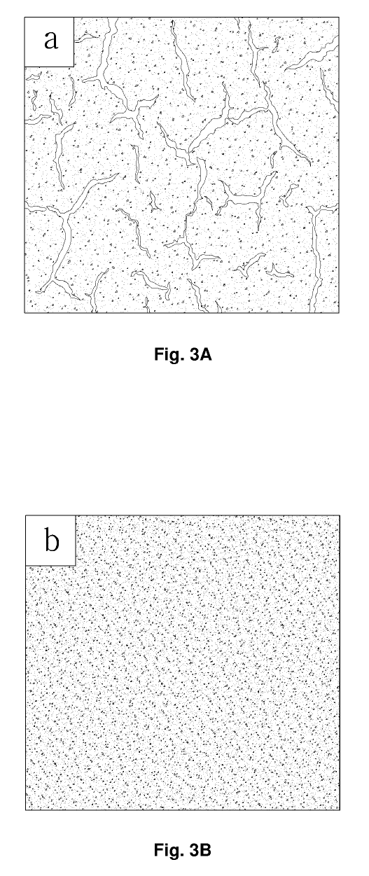

In certain embodiments, as a test example, a mixed solvent of IPA/H₂O in a ratio of 45:55 (FIG. 3A) and a mixed solvent of IPA/H₂O/EE in a ratio of 45:28:27 (FIG. 3B) were preferably used in preparing catalyst slurries for manufacturing catalyst layers and the surfaces of the thus manufactured catalyst layers were suitably measured using a scanning electron microscope (SEM).

As shown in FIGS. 3A and 3B, the surface state of the catalyst layer formed of the catalyst slurry, to which 2-ethoxyethanol was added (FIG. 3B), was considerably clear since there was no occurrence of cracks, compared to the catalyst layer formed of the mixed solvent of IPA/H₂O (FIG. 3A). Based on the results, the ratio of solvents used in manufacturing the catalyst slurry was suitably determined.

In preferred embodiments of the present invention, an electrode optimized by the above-described technique is suitably adopted to optimize the MEA manufacturing process. According to exemplary embodiment, for example as shown in FIG. 1, panel (b) shows an MEA manufacturing process employing a decal method proposed by the present invention. Preferably, during manufacturing of the MEA, the decal method has the following advantages. In one preferred embodiment, since it is easy to control the thickness and area of the catalyst layer, it is possible to ensure suitably high mass productivity of the MEA. In another embodiment, the decal method corresponding to a catalyst-coated membrane (CCM) method can suitably reduce the contact resistance between the polymer electrolyte membrane and the catalyst layer, compared to a catalyst-coated GDL (CCG) method. In another further embodiment, it is possible to form a dense catalyst layer by thermocompression during decaling, thus improving the durability. In other embodiments, the porosity of the catalyst layer is reduced when using the decal method, and thus the initial cell performance is deteriorated compared to the CCG method. Accordingly, an optimization design of the catalyst layer is provided by the present invention.

The MEA manufacturing process will be described in detail below according to preferred embodiments of the present invention. According to a first embodiment, the prepared catalyst slurry is suitably coated on the surface of a release film (e.g., PI., PTFE, PET, etc.) to a thickness of about 20, 25, 30, 35, 40, 45, 50, 55, 60, 65, 70, 75, 80, 85, 90, 95, 100, 105, 110, 115, 120, 125 μm, preferably 30 to 100 μm, preferably using a bar (or slot die) and then dried at 70 to 90° C. for more than 10 hours. If necessary, in further embodiments, a second heat treatment process is performed at 100 to 200° C. for several hours, thus suitably obtaining a catalyst layer.

According to preferred embodiments of the invention, the reason that the heat treatment process is performed on the catalyst layer is to remove the solvent in the catalyst layer and suitably improve hydrogen ion conductivity and durability by increasing ionomer crystallization.

In further preferred embodiments, the above drying process includes a first heat treatment process, preferably performed at about 80° C. for 12 hours, to form an electrode and a second heat treatment, preferably performed at 100 to 120° C. for more than 30 minutes, to suitably increase internal bonding of the catalyst layer.

In other further embodiments, as a next step, the thus obtained catalyst layer is suitably decaled onto both sides of an electrolyte membrane using a hot press to form a 3-layer MEA. As determined by suitable experimentation, a suitable pressure applied to the decaling process is about 10 kgf/cm², and an optimum temperature is in the range of 120 to 160° C. According to preferred embodiments, as a final step, a GDL is suitably bonded to both sides of the thus formed 3-layer MEA, thus forming a 5-layer MEA.

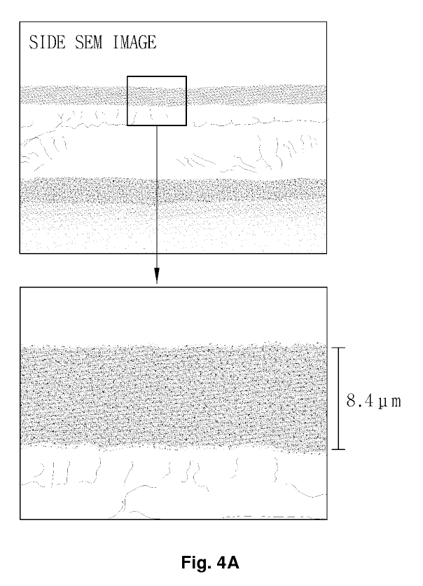

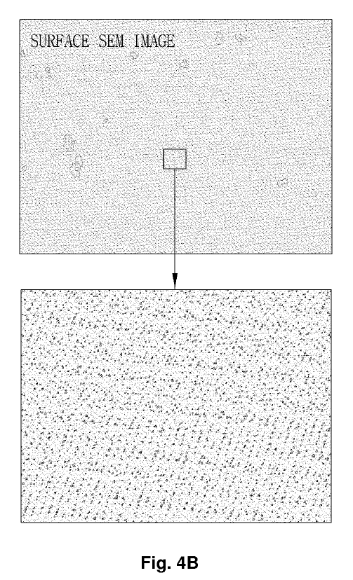

In exemplary embodiments, structural analysis was performed by FE-SEM measurement in order to more closely examine the long-term durability and quality of the thus formed 5-layer MEA, and the results are shown in FIGS. 4A and 4B. It can be seen from FIG. 4A showing the side of the thus formed 5-layer MEA that the thickness of the catalyst layer is very small and its structure is suitably very dense. Moreover, according to further embodiments, it can be seen that the thickness of the catalyst layer is considerably uniform and the interface bonding between the polymer electrolyte membrane and the catalyst layer is good. According to further embodiments, it can be seen from FIG. 4B showing the surface of the MEA that the catalyst layer has a considerably smooth surface, on which several tens to several hundreds of pores are suitably uniformly distributed. The smooth surface of the catalyst layer suitably increases the interface bonding force with the GDL, and thus reduces the contact resistance, which leads to an improvement in the performance. Accordingly, in preferred embodiments, since nanopores having a diameter of 0.2 to 1 um are uniformly and sufficiently distributed, fuel gas diffusion or material transfer is smoothly made during operation of the fuel cell, which leads to an improvement in the output performance. As a result, according to the method for manufacturing an MEA of the present invention, since the defect rate is suitably low, the quality is excellent and, since the performance variation is small and the interface bonding force between the polymer electrolyte membrane and the electrode is quite good, the durability is suitably improved, thereby enabling to manufacture an MEA having high performance.

As described herein, according to the method for manufacturing a MEA for a polymer electrolyte membrane fuel cell of the present invention, a highly-concentrated catalyst slurry which is uniformly dispersed, compared to the conventional catalyst slurries, is preferably provided to prevent the performance deterioration due to ununiformity of catalyst dispersion and assembly conditions and improve the adsorption ununiformity between the ionomers and the catalyst, thus improving the catalyst utilization. Accordingly, the preferred ratio of solvents used in the catalyst slurry dispersion is suitably controlled to ensure uniform coating and prevent the occurrence of cracks, thus suitably improving the electrode performance. Thus, according to preferred embodiments of the invention as described herein, it is possible to optimize the method for manufacturing an MEA using the decal method having high mass productivity, thus suitably manufacturing an electrode for a polymer electrolyte membrane fuel cell having high performance and an MEA including the same.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method for manufacturing an electrode for a polymer electrolyte membrane fuel cell, the method comprising:
dispersing initial catalyst particles by ultrasonic waves and high-speed stirring;
allowing ionomers to be filled and adsorbed into primary pores of the catalyst particles by vacuum defoaming;
dispersing a small amount of residual large catalyst particles by bead milling;
removing microbubbles generated during manufacturing process;
forming a catalyst slurry from which large catalyst particles are removed by final filtering; and
coating the catalyst slurry on a surface of a release film and drying the coated catalyst slurry.

2. The method of claim 1, wherein a mixed solvent of isopropyl alcohol and water is used when dispersing the catalyst particles, and the mixed solvent further comprises at least one selected from the group consisting of ethoxyethanol, butoxyethanol, and N-methylpyrrolidone (NMP) in an amount of 0.1 to 50%.

3. The method of claim 1, wherein, in drying the coated catalyst slurry, the drying process comprises a first heat treatment process performed at 70 to 90° C. for more than 10 hours and a second heat treatment performed at 100 to 120° C. for more than 30 minutes.

4. An electrode for a polymer electrolyte membrane fuel cell manufactured by the method of claim 1.

5. A method for manufacturing a membrane-electrode assembly for a polymer electrolyte membrane fuel cell, the method comprising:
dispersing initial catalyst particles by ultrasonic waves and high-speed stirring;
allowing ionomers to be filled and adsorbed into primary pores of the catalyst particles by vacuum defoaming;
dispersing a small amount of residual large catalyst particles by bead milling;
removing microbubbles generated during manufacturing process;
forming a catalyst slurry from which large catalyst particles are removed by final filtering;
forming a catalyst layer by coating the catalyst slurry on a surface of a release film and drying the coated catalyst slurry; and
forming a 3-layer membrane-electrode assembly by decaling the formed catalyst layer on both sides of a polymer electrolyte membrane using a hot press.

6. The method of claim 5, further comprising forming a 5-layer membrane-electrode assembly by bonding a gas diffusion layer (GDL) on both sides of a 3-layer membrane-electrode assembly.

7. The method of claim 5, wherein a mixed solvent of water and isopropyl alcohol or ethanol is used when dispersing the catalyst particles, and the mixed solvent further comprises at least one selected from the group consisting of ethoxyethanol, butoxyethanol, and N-methylpyrrolidone (NMP) in an amount of 0.1 to 50%.

8. The method of claim 5, wherein, in drying the coated catalyst slurry, the drying process comprises a first heat treatment process performed at 70 to 90° C. for more than 10 hours and a second heat treatment performed at 100 to 120° C. for more than 30 minutes.

9. A membrane-electrode assembly for a polymer electrolyte membrane fuel cell manufactured by the method of claim 5.

10. A method for manufacturing an electrode for a polymer electrolyte membrane fuel cell, the method comprising:
dispersing initial catalyst particles;
allowing ionomers to be filled and adsorbed into primary pores of the catalyst particles;
dispersing a small amount of residual large catalyst particles;
removing microbubbles generated during manufacturing process;
forming a catalyst slurry; and
coating the catalyst slurry on a surface of a release film.

11. The method for manufacturing an electrode for a polymer electrolyte membrane fuel cell of claim 10, wherein the initial catalyst particles are dispersed by by ultrasonic waves and high-speed stirring.

12. The method for manufacturing an electrode for a polymer electrolyte membrane fuel cell of claim 10, wherein the ionomers are filled and adsorbed into primary pores of the catalyst particles by vacuum defoaming.

13. The method for manufacturing an electrode for a polymer electrolyte membrane fuel cell of claim 10, wherein the small amount of residual large catalyst particles are dispersed by bead milling.

14. The method for manufacturing an electrode for a polymer electrolyte membrane fuel cell of claim 10, wherein large catalyst particles are removed from the catalyst slurry by final filtering.

15. The method for manufacturing an electrode for a polymer electrolyte membrane fuel cell of claim 10, further comprising the step of drying the coated catalyst slurry.

16. The method for manufacturing an electrode for a polymer electrolyte membrane fuel cell of claim 10, further comprising the step of forming a 3-layer membrane-electrode assembly.

17. The method for manufacturing an electrode for a polymer electrolyte membrane fuel cell of claim 16, wherein the step of forming a 3-layer membrane-electrode assembly is carried out by decaling the formed catalyst layer on both sides of a polymer electrolyte membrane using a hot press.

18. A motor vehicle comprising an electrode for a polymer electrolyte membrane fuel cell of manufactured by the method of claim 1.

19. A motor vehicle comprising an electrode for a polymer electrolyte membrane fuel cell of manufactured by the method of claim 10.
